(19) United States
(12) Patent Application Publication
(10) Pub. No.: US 2014/0038622 A1
(43) Pub. Date: Feb. 6, 2014

(54) METHODS AND APPARATUS FOR EFFICIENT COMMUNICATION OF SMALL DATA AMOUNTS WHILE IN IDLE MODE

(71) Applicant: Qualcomm Incorporated, (US)

(72) Inventors: Xipeng Zhu, Beijing (CN); Rohit Kapoor, San Diego, CA (US); Francesco Pica, San Diego, CA (US)

(73) Assignee: Qualcomm Incorporated, San Diego, CA (US)

(21) Appl. No.: 13/775,950

(22) Filed: Feb. 25, 2013

Related U.S. Application Data
(60) Provisional application No. 61/650,044, filed on May 22, 2012.

(51) Int. Cl. H04W 72/02

(52) U.S. Cl. CPC H04W 72/02
USPC 455/450

(57) ABSTRACT

A method, an apparatus, and a computer program product for wireless communication are provided in connection with enabling communication of small data amounts while maintaining a RRC idle mode of operation for a UE. In an example, a UE is equipped to obtain a temporary radio bearer for communication of data, that meets one or more criteria for small data transmission, over a user plane in a UMTS or LTE based network, and transmit the data, over the user plane, using the temporary radio bearer while maintaining the UE in an RRC idle mode. A UTRAN entity may receive, over the temporary radio bearer assignment, the data from a UE in an idle mode, and send the data to a SGSN using a common small data connection. The SGSN may then send the data to a PGW.

### CLAIM OF PRIORITY UNDER 35 U.S.C. §119

The present application for patent claims priority to Provisional Application No. 61/650,044 entitled “Common Iu/S1 for User Plane Small Data Transmission” filed May 22, 2012, and assigned to the assignee hereof and hereby expressly incorporated by reference herein.

### BACKGROUND

1. Field

The present disclosure relates generally to communication systems, and more particularly, to improving communication of small data amounts while maintaining a radio resource control (RRC) idle mode of operation.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division—Code Division Multiple Access (TD-CDMA), and Time Division—Synchronous Code Division Multiple Access (TD-SCDMA). The UMTS also supports enhanced 3G data communications protocols, such as High Speed Packet Access (HSPA), which provides higher data transfer speeds and capacity to associated UMTS networks.

As the demand for mobile broadband access continues to increase, research and development continue to advance the UMTS technologies not only to meet the growing demand for mobile broadband access, but to advance and enhance the user experience with mobile communications.

A form of communications used in a 3GPP based access network is machine-to machine (M2M) communications. Generally, devices communicating machine-to machine (M2M) (e.g., M2M devices) may communicate small data amounts, and such communications may occur infrequently. Currently, to communicate the data the M2M device (e.g., user equipment (UE)) performs a full service request procedure to switch from a RRC idle mode to a RRC active mode. The small amounts of data that may be communicated after the M2M device is in a RRC active mode may be small in comparison to the signals needed to perform the full service request procedure.

Therefore, methods and apparatuses are needed to efficiently communicate small data amounts while maintaining a radio resource control (RRC) idle mode of operation.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with one or more aspects and corresponding disclosure thereof, various aspects are described in connection with enabling communication of small data amounts while maintaining a radio resource control (RRC) idle mode of operation for a UE. In an example, a UE is equipped to obtain a temporary radio bearer for communication of data, that meets one or more criteria for small data transmission, over a user plane in a UMTS or long term evolution (LTE) based network, and transmit the data, over the user plane, using the temporary radio bearer while maintaining the UE in an RRC idle mode. In another example, a UMTS terrestrial radio access network (UTRAN) entity (e.g., radio network controller (RNC)) is equipped to receive, over a temporary radio bearer assignment, data that meets one or more criteria for small data transmission over a user plane from a UE in an idle mode, and send the data to a serving general packet radio service (GPRS) Support Node (SGSN) using a common small data connection. In still another example, a SGSN is equipped to receive data over a common small data connection from a UTRAN, and send the data to a gateway GPRS support node (GGSN)/PDN gateway (PGW). In an aspect, the data may meet one or more criteria for small data transmission over a user plane from a UE in an idle mode.

According to related aspects, a method for enabling communication of small data amounts while maintaining a RRC idle mode of operation for a UE is provided. The method can include obtaining a temporary radio bearer for communication of data, that meets one or more criteria for small data transmission, over a user plane in a UMTS or LTE based network. Moreover, the method may include transmitting the data over the user plane using the temporary radio bearer while maintaining the UE in an RRC idle mode.

Another aspect relates to a communications apparatus for enabling communication of small data amounts while maintaining a RRC idle mode of operation for a UE. The communications apparatus can include means for obtaining a temporary radio bearer for communication of data, that meets one or more criteria for small data transmission, over a user plane in a UMTS or LTE based network. Moreover, the communications apparatus can include means for transmitting the data over the user plane using the temporary radio bearer while maintaining the UE in an RRC idle mode.

Another aspect relates to a communications apparatus. The apparatus can include a processing system configured to obtain a temporary radio bearer for communication of data, that meets one or more criteria for small data transmission, over a user plane in a UMTS or LTE based network. Moreover, the processing system may further be configured to transmit the data over the user plane using the temporary radio bearer while maintaining the UE in an RRC idle mode.

Still another aspect relates to a computer program product, which can have a computer-readable medium including code for obtaining a temporary radio bearer for communication of data, that meets one or more criteria for small data transmission, over a user plane in a UMTS or LTE based network. Moreover, the computer-readable medium can include code for transmitting the data over the user plane using the temporary radio bearer while maintaining the UE in an RRC idle mode.

According to related aspects, a method for enabling communication of small data amounts while maintaining a RRC idle mode of operation for a UE is provided. The method can include receiving, over a temporary radio bearer assignment, data that meets one or more criteria for small data transmission over a user plane from a UE in an idle mode. Moreover, the method may include sending the data to a SGSN using a common small data connection.

Another aspect relates to a communications apparatus for enabling communication of small data amounts while maintaining a RRC idle mode of operation for a UE. The communications apparatus can include means for receiving, over a temporary radio bearer assignment, data that meets one or more criteria for small data transmission over a user plane from a UE in an idle mode. Moreover, the communications apparatus can include means for sending the data to a SGSN using a common small data connection.

Another aspect relates to a communications apparatus. The apparatus can include a processing system configured to receive, over a temporary radio bearer assignment, data that meets one or more criteria for small data transmission over a user plane from a UE in an idle mode. Moreover, the processing system may further be configured to send the data to a SGSN using a common small data connection.

Still another aspect relates to a computer program product, which can have a computer-readable medium including code for receiving, over a temporary radio bearer assignment, data that meets one or more criteria for small data transmission over a user plane from a UE in an idle mode. Moreover, the computer-readable medium can include code for sending the data to a SGSN using a common small data connection.

According to related aspects, a method for enabling communication of small data amounts while maintaining a RRC idle mode of operation for a UE is provided. The method can include receiving data over a common small data connection from a UTRAN. In an aspect, the data may meet one or more criteria for small data transmission over a user plane from a UE in an idle mode. Moreover, the method may include sending the data to a PGW.

Another aspect relates to a communications apparatus for enabling communication of small data amounts while maintaining a RRC idle mode of operation for a UE. The communications apparatus can include means for receiving data over a common small data connection from a UTRAN. In an aspect, the data may meet one or more criteria for small data transmission over a user plane from a UE in an idle mode. Moreover, the communications apparatus can include means for sending the data to a PGW.

Another aspect relates to a communications apparatus. The apparatus can include a processing system configured to receive data over a common small data connection from a UTRAN. In an aspect, the data may meet one or more criteria for small data transmission over a user plane from a UE in an idle mode. Moreover, the processing system may further be configured to send the data to a PGW.

Still another aspect relates to a computer program product, which can have a computer-readable medium including code for receiving data over a common small data connection from a UTRAN. In an aspect, the data may meet one or more criteria for small data transmission over a user plane from a UE in an idle mode. Moreover, the computer-readable medium can include code for sending the data to a PGW.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of an access network architecture.

FIG. 2 is a diagram illustrating an example of another access network architecture.

FIG. 3 is a diagram illustrating an example of a network entity and user equipment in an access network.

FIG. 4 is a diagram illustrating an example of another access network architecture, according to an aspect.

FIG. 5 is a call flow diagram illustrating an access network in which connectionless data transmission operations may be enabled, according to an aspect.

FIG. 6 is a flow chart illustrating a first example method for providing connectionless data transmission operations, according to an aspect.

FIG. 7 is a conceptual data flow diagram illustrating the data flow between different modules/means/components in an exemplary apparatus.

FIG. 8 is a diagram illustrating an example of a hardware implementation for an apparatus employing a processing system.

FIG. 9 is a flow chart illustrating a second example method for providing connectionless data transmission operations, according to an aspect.

FIG. 10 is a conceptual data flow diagram illustrating the data flow between different modules/means/components in an exemplary apparatus.

FIG. 11 is a diagram illustrating an example of a hardware implementation for an apparatus employing a processing system.

FIG. 12 is a flow chart illustrating a second example method for providing connectionless data transmission operations, according to an aspect.

FIG. 13 is a conceptual data flow diagram illustrating the data flow between different modules/means/components in an exemplary apparatus.

FIG. 14 is a diagram illustrating an example of a hardware implementation for an apparatus employing a processing system.

FIG. 15 is a diagram 1500 illustrating an example of a hardware implementation for an apparatus 1402′ employing a processing system 1514.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media.

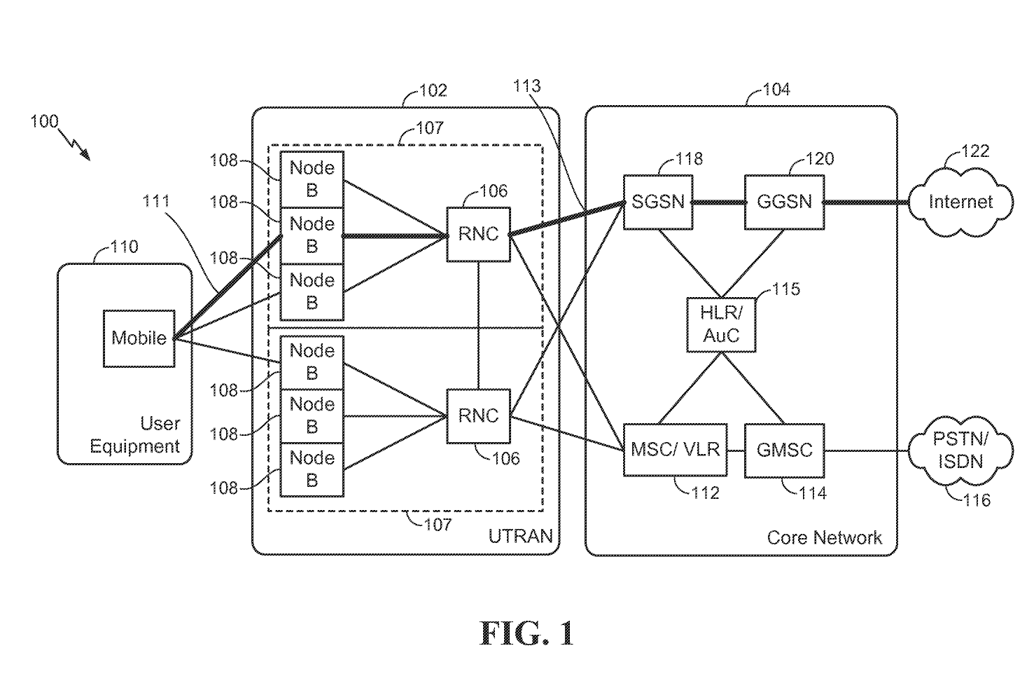

By way of example and without limitation, the aspects of the present disclosure illustrated in FIG. 1 are presented with reference to a UMTS system 100 employing a W-CDMA air interface and/or CDMA2000 air interface. A UMTS network includes three interacting domains: a Core Network (CN) 104, a UMTS Terrestrial Radio Access Network (UTRAN) 102, and User Equipment (UE) 110. In this example, the UTRAN 102 provides various wireless services including telephony, video, data, messaging, broadcasts, and/or other services. The UTRAN 102 may include a plurality of Radio Network Subsystems (RNSs) such as an RNS 107, each controlled by a respective Radio Network Controller (RNC) such as an RNC 106. Here, the UTRAN 102 may include any number of RNCs 106 and RNSs 107 in addition to the RNCs 106 and RNSs 107 illustrated herein. The RNC 106 is an apparatus responsible for, among other things, assigning, reconfiguring, and releasing radio resources within the RNS 107. The RNC 106 may be interconnected to other RNCs (not shown) in the UTRAN 102 through various types of interfaces such as a direct physical connection, a virtual network, or the like, using any suitable transport network.

Communication between a UE 110 and a Node B 108 may be considered as including a physical (PHY) layer and a medium access control (MAC) layer. Further, communication between a UE 110 and an RNC 106 by way of a respective Node B 108 may be considered as including a radio resource control (RRC) layer. In the instant specification, the PHY layer may be considered layer 1; the MAC layer may be considered layer 2; and the RRC layer may be considered layer 3. Information hereinbelow utilizes terminology introduced in the RRC Protocol Specification, 3GPP TS 25.331 v9.1.0, incorporated herein by reference.

The geographic region covered by the RNS 107 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 108 are shown in each RNS 107; however, the RNSs 107 may include any number of wireless Node Bs. The Node Bs 108 provide wireless access points to a CN 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as a UE in UMTS applications, but may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology. For illustrative purposes, one UE 110 is shown in communication with a number of the Node Bs 108. The DL, also called the forward link, refers to the communication link from a Node B 108 to a UE 110, and the UL, also called the reverse link, refers to the communication link from a UE 110 to a Node B 108.

The CN 104 interfaces with one or more access networks, such as the UTRAN 102. As shown, the CN 104 is a GSM core network. However, as those skilled in the art will recognize, the various concepts presented throughout this disclosure may be implemented in a RAN, or other suitable access network, to provide UEs with access to types of CNs other than GSM networks.

The CN 104 includes a circuit-switched (CS) domain and a packet-switched (PS) domain. Some of the circuit-switched elements are a Mobile services Switching Centre (MSC) 112, a Visitor location register (VLR), and a Gateway MSC. Packet-switched elements include a Serving GPRS Support Node (SGSN) and a Gateway GPRS Support Node (GGSN). Some network elements, like EIR, HLR, VLR and AuC may be shared by both of the circuit-switched and packet-switched domains. In the illustrated example, the CN 104 supports circuit-switched services with a MSC 112 and a GMSC 114. In some applications, the GMSC 114 may be referred to as a media gateway (MGW). One or more RNCs, such as the RNC 106, may be connected to the MSC 112. The MSC 112 is an apparatus that controls call setup, call routing, and UE mobility functions. The MSC 112 may also include a VLR that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) 115 containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR 115 to determine the UE's location and forwards the call to the particular MSC serving that location.

The CN 104 also supports packet-data services with a serving General Packet Radio Service (GPRS) support node (SGSN) 118 and a gateway GPRS support node (GGSN) 120. GPRS is designed to provide packet-data services at speeds higher than those available with standard circuit-switched data services. The GGSN 120 provides a connection for the UTRAN 102 to a packet-based network 122. The packet-based network 122 may be the Internet, a private data network, or some other suitable packet-based network. The primary function of the GGSN 120 is to provide the UEs 110 with packet-based network connectivity. Data packets may be transferred between the GGSN 120 and the UEs 110 through the SGSN 118, which performs primarily the same functions in the packet-based domain as the MSC 112 performs in the circuit-switched domain.

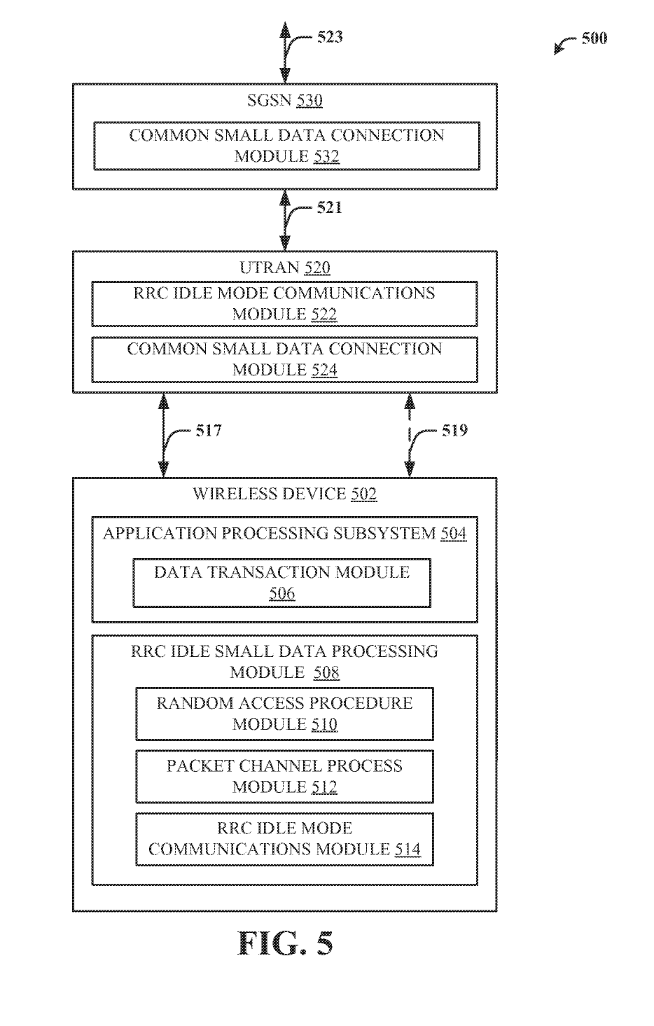

In an operational aspect, small data amounts (e.g., machine-to-machine (M2M) communications) may be communicated between UE 110 and GGSN 120/internet 122 following bolded data path 111. In such an aspect, a common small data connection 113 may be established and maintained between RNC 108 and SGSN 118. Further description of the small data communication path 111 and the common small data connection 113 are provided below with reference to FIG. 5.

An air interface for UMTS may utilize a spread spectrum Direct-Sequence Code Division Multiple Access (DS-CDMA) system. The spread spectrum DS-CDMA spreads user data through multiplication by a sequence of pseudorandom bits called chips. The “wideband” W-CDMA air interface for UMTS is based on such direct sequence spread spectrum technology and additionally calls for a frequency division duplexing (FDD). FDD uses a different carrier frequency for the UL and DL between a Node B 108 and a UE 110. Another air interface for UMTS that utilizes DS-CDMA, and uses time division duplexing (TDD), is the TD-SCDMA air interface. Those skilled in the art will recognize that although various examples described herein may refer to a W-CDMA air interface, the underlying principles may be equally applicable to a TD-SCDMA air interface.

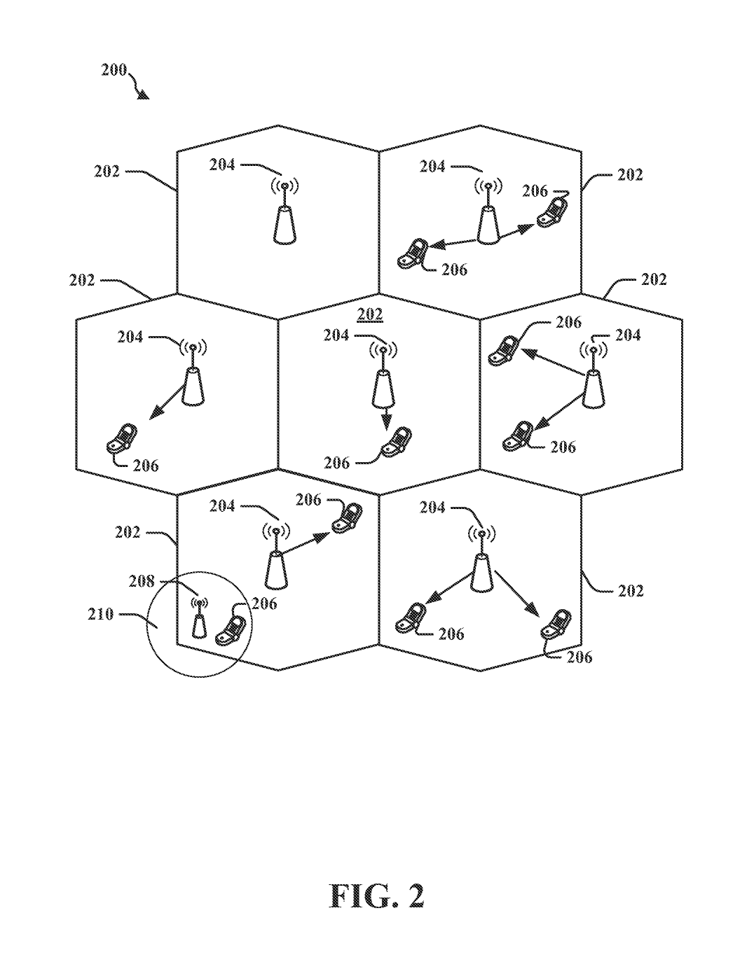

FIG. 2 is a diagram illustrating an example of an access network 200 in an LTE network architecture. In this example, the access network 200 is divided into a number of cellular regions (cells) 202. One or more lower power class eNBs 208 may have cellular regions 210 that overlap with one or more of the cells 202. The lower power class eNB 208 may be a femto cell (e.g., home eNB (HeNB)), pico cell, micro cell, or remote radio head (RRH). The macro eNBs 204 are each assigned to a respective cell 202 and are configured to provide an access point to the EPC for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway.

The modulation and multiple access scheme employed by the access network 200 may vary depending on the particular telecommunications standard being deployed. In LTE applications, OFDM is used on the DL and SC-FDMA is used on the UL to support both frequency division duplexing (FDD) and time division duplexing (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data steams may be transmitted to a single UE 206 to increase the data rate or to multiple UEs 206 to increase the overall system capacity. This is achieved by spatially precoding each data stream (i.e., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

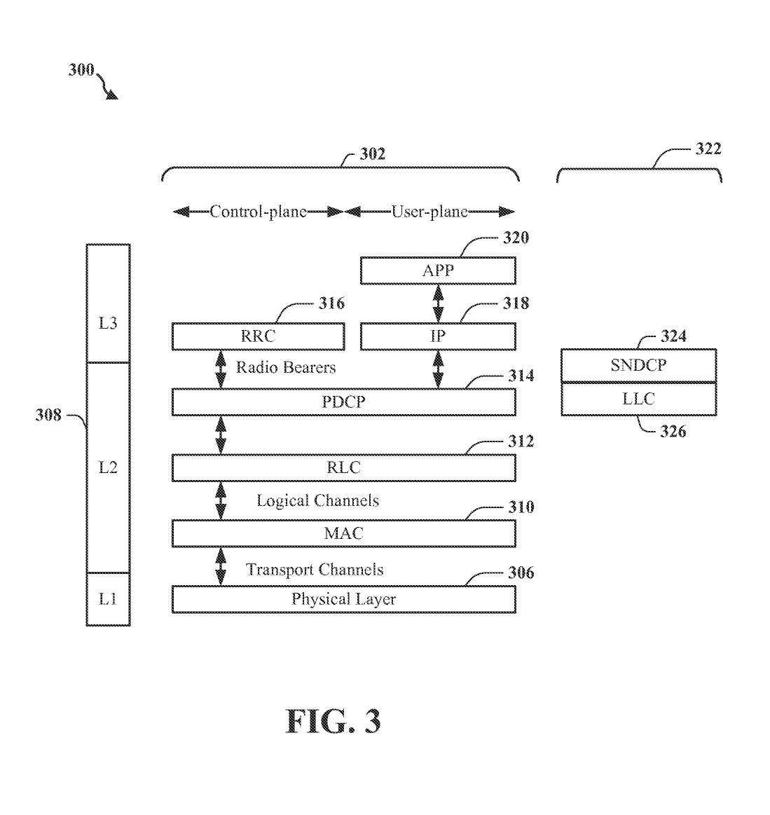

FIG. 3 is a diagram 300 illustrating an example of a radio protocol architecture for the user and control planes. The radio protocol architecture for the 302 UE and the eNB is shown with three layers: Layer 1, Layer 2, and Layer 3. Communication 322 of data/signaling may occur between UE 302 and eNB 304 across the three layers. Layer 1 (L1 layer) is the lowest layer and implements various physical layer signal processing functions. The L1 layer will be referred to herein as the physical layer 306. Layer 2 (L2 layer) 308 is above the physical layer 306 and is responsible for the link between the UE and eNB over the physical layer 306.

In the user plane, the L2 layer 308 includes a media access control (MAC) sublayer 310, a radio link control (RLC) sublayer 312, and a packet data convergence protocol (PDCP) 314 sublayer, which are terminated at the eNB on the network side. As described below, the UE may have several upper layers above the L2 layer 308 including a network layer (e.g., IP layer 318) that is terminated at the PDN gateway 118 on the network side, and an application layer 320 that is terminated at the other end of the connection (e.g., far end UE, server, etc.).

In an aspect in which a UE supports a general packet radio service (GPRS) based user plane protocol stack 322 may include a Sub Network Dependent Convergence Protocol (SNDCP) 324, and logical link layer 326 between the RLC sublayer 312 and the IP sublayer 318. In such an aspect, SNDCP 324 and LLC 326 may be terminated to the SGSN 118.

The PDCP sublayer 314 provides multiplexing between different radio bearers and logical channels. The PDCP sublayer 314 also provides header compression for upper layer data packets to reduce radio transmission overhead, security by ciphering the data packets, and handover support for UEs between eNBs. The RLC sublayer 312 provides segmentation and reassembly of upper layer data packets, retransmission of lost data packets, and reordering of data packets to compensate for out-of-order reception due to hybrid automatic repeat request (HARQ). The MAC sublayer 310 provides multiplexing between logical and transport channels. The MAC sublayer 310 is also responsible for allocating the various radio resources (e.g., resource blocks) in one cell among the UEs. The MAC sublayer 310 is also responsible for HARQ operations.

In the control plane, the radio protocol architecture for the UE and eNB is substantially the same for the physical layer 306 and the L2 layer 308 with the exception that there is no header compression function for the control plane. The control plane also includes a radio resource control (RRC) sublayer 316 in Layer 3 (L3 layer). The RRC sublayer 316 is responsible for obtaining radio resources (i.e., radio bearers) and for configuring the lower layers using RRC signaling between the eNB and the UE 302. The user plane also includes an internet protocol (IP) sublayer 318 and an application sublayer 320. The IP sublayer 318 and application sublayer 320 are responsible for supporting communication of application data between the eNB 304 and the UE 302.

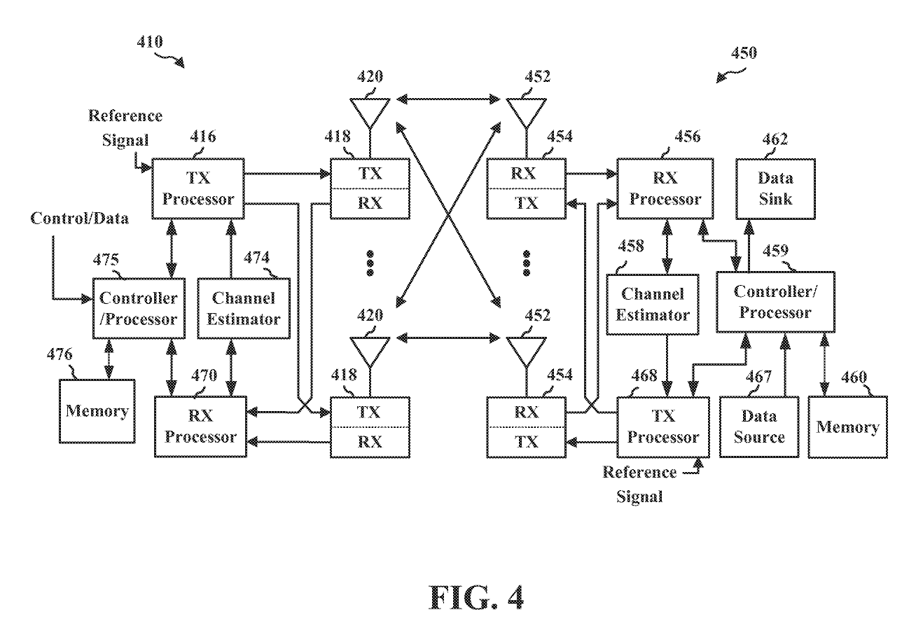

FIG. 4 is a block diagram of a network entity 410 (e.g., NB, eNB, RNC, SGSN, GGSN, etc.) in communication with a UE 450 in an access network. In the DL, upper layer packets from the core network are provided to a controller/processor 475. The controller/processor 475 implements the functionality of the L2 layer. In the DL, the controller/processor 475 provides header compression, ciphering, packet segmentation and reordering, multiplexing between logical and transport channels, and radio resource allocations to the UE 450 based on various priority metrics. The controller/processor 475 is also responsible for HARQ operations, retransmission of lost packets, and signaling to the UE 450.

The transmit (TX) processor 416 implements various signal processing functions for the L1 layer (i.e., physical layer). The signal processing functions includes coding and interleaving to facilitate forward error correction (FEC) at the UE 450 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 474 may be used to determine the coding and modulation scheme, as well as for spatial processing. The channel estimate may be derived from a reference signal and/or channel condition feedback transmitted by the UE 450. Each spatial stream is then provided to a different antenna 420 via a separate transmitter 418TX. Each transmitter 418TX modulates an RF carrier with a respective spatial stream for transmission.

At the UE 450, each receiver 454RX receives a signal through its respective antenna 452. Each receiver 454RX recovers information modulated onto an RF carrier and provides the information to the receive (RX) processor 456. The RX processor 456 implements various signal processing functions of the L1 layer. The RX processor 456 performs spatial processing on the information to recover any spatial streams destined for the UE 450. If multiple spatial streams are destined for the UE 450, they may be combined by the RX processor 456 into a single OFDM symbol stream. The RX processor 456 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, is recovered and demodulated by determining the most likely signal constellation points transmitted by the network entity 410. These soft decisions may be based on channel estimates computed by the channel estimator 458. The soft decisions are then decoded and deinterleaved to recover the data and control signals that were originally transmitted by the network entity 410 on the physical channel. The data and control signals are then provided to the controller/processor 459.

The controller/processor 459 implements the L2 layer. The controller/processor can be associated with a memory 460 that stores program codes and data. The memory 460 may be referred to as a computer-readable medium. In the UL, the controller/processor 459 provides demultiplexing between transport and logical channels, packet reassembly, deciphering, header decompression, control signal processing to recover upper layer packets from the core network. The upper layer packets are then provided to a data sink 462, which represents all the protocol layers above the L2 layer. Various control signals may also be provided to the data sink 462 for L3 processing. The controller/processor 459 is also responsible for error detection using an acknowledgement (ACK) and/or negative acknowledgement (NACK) protocol to support HARQ operations.

In the UL, a data source 467 is used to provide upper layer packets to the controller/processor 459. The data source 467 represents all protocol layers above the L2 layer. Similar to the functionality described in connection with the DL transmission by the network entity 410, the controller/processor 459 implements the L2 layer for the user plane and the control plane by providing header compression, ciphering, packet segmentation and reordering, and multiplexing between logical and transport channels based on radio resource allocations by the network entity 410. The controller/processor 459 is also responsible for HARQ operations, retransmission of lost packets, and signaling to the network entity 410.

Channel estimates derived by a channel estimator 458 from a reference signal or feedback transmitted by the network entity 410 may be used by the TX processor 468 to select the appropriate coding and modulation schemes, and to facilitate spatial processing. The spatial streams generated by the TX processor 468 are provided to different antenna 452 via separate transmitters 454TX. Each transmitter 454TX modulates an RF carrier with a respective spatial stream for transmission.

The UL transmission is processed at the network entity 410 in a manner similar to that described in connection with the receiver function at the UE 450. Each receiver 418RX receives a signal through its respective antenna 420. Each receiver 418RX recovers information modulated onto an RF carrier and provides the information to a RX processor 470. The RX processor 470 may implement the L1 layer.

The controller/processor 475 implements the L2 layer. The controller/processor 475 can be associated with a memory 476 that stores program codes and data. The memory 476 may be referred to as a computer-readable medium. In the UL, the controller/processor 475 provides demultiplexing between transport and logical channels, packet reassembly, deciphering, header decompression, control signal processing to recover upper layer packets from the UE 450. Upper layer packets from the controller/processor 475 may be provided to the core network. The controller/processor 475 is also responsible for error detection using an ACK and/or NACK protocol to support HARQ operations.

FIG. 5 depicts an example communication network 500 in which connectionless data transmission (e.g., data transmission will in a RRC idle mode) of small amounts of data may be enabled, according to an aspect.

Communication network 500 may include a wireless device 502 (e.g., M2M end device, M2M gateway, or M2M client device, UE, etc.), and a UTRAN entity 520 (e.g., RNC), and a SGSN 530. In an aspect, communication network 500 may further be connected to a network entity (e.g., M2M server, etc.) through connection 523.

Wireless device 502 may include, among other components/modules/subsystems, an application processing subsystem 504, and a RRC idle small data processing module 508. In an aspect, application processing subsystem 504 may use data transaction module 506 to obtain data as part of M2M communications. For example, data transaction module 506 may obtain data from one or more sensors associated with wireless device 502, may generate a “keep alive” message for an application, etc. RRC idle small data processing module 508 may determine whether the obtained data may be categorized as small data (e.g., a small data amount). In such an aspect, the obtained data may be categorized as small data based on a packet size for the data, a number of uplink (UL) packets for communication by the wireless device 502, wireless device 502 local configurations, an indication from an application associated with the wireless device 502, etc.

RRC idle small data processing module 508 may include random access procedure module 510, packet channel process module 512 and RRC idle mode communications module 514. In an aspect, RRC idle small data processing module 508 may enable wireless device 502 to operate in a special idle state. In such a special idle state, the wireless device 502 may have no UE context and may not have a full UE context with the UTRAN 520. Further, no permanent resource allocation is provided to the wireless device 502, and there is no RRC connection with the wireless device 502. In an aspect in which the wireless device 502 is in RRC connected mode, the data may be communicated 519 using a IP layer PDU.

In an aspect, random access procedure module 510 may perform a random access procedure. In such an aspect, random access procedure module 510 may establish a RACH with UTRAN 520. In an aspect in which wireless device 502 moves to receive service from a new cell, random access procedure module 510 may be configured to may re-initiate the random access procedure and may send at least one packet in the new cell if resource allocation (RA) is not changed. In such an aspect, the UTRAN 520 may run ARQ to repeat packets that may have been lost due to the cell change.

Using the established RACH, packet channel process module 512 may obtain a temporary radio bearer to use for communication of the small data. In such an aspect, wireless device 502 may send a packet channel request to UTRAN 520. In an aspect, the request may include a temporary logical link identifier (TLLI) as a UE identifier. In response to the request, UTRAN 520 may assign a temporary radio bearer (similar to temporary block flow (TBF) of GPRS) and a Radio Network Temporary identifier (RNTI) for the wireless device 502. In an aspect, the temporary radio bearer may be valid for a time period, a number of packets, etc. In another aspect, one or more default UE radio capability categories may be defines so as to avoid transmission of a full UE radio capability informational element (IE) in the request.

Based on the obtained temporary radio bearer, RRC idle mode communications module 514 may communicate 517 the small data to UTRAN 520. In an aspect in which the small data is communicated using a GPRS based protocol stack in a UMTS environment, RRC idle mode communications module 514 may communicate 517 the small data (e.g., IP PDU) in a RLC/MAC PDU. Further in such an aspect, RRC idle mode communications module 514 may include Sub Network Dependent Convergence Protocol (SNDCP), LLC, and service access point identifier (NSAPI) information in the RLC/MAC PDU (e.g., RLC/MAC PDU (TLLI, LLC (SNDCP (NSAPI, IP PDU))). When the GPRS based protocol stack is used in a UMTS environment, header compression may be handled by SNDCP, user plane security may be handled by LLC, and packet data protocol (PDP) context may be identified by NSAPI. In an aspect in which the small data is communicated using a UMTS based protocol stack, RRC idle mode communications module 514 may communicate 517 the small data (e.g., IP PDU) in a Packet Data Convergence Protocol (PDCP) PDU.

UTRAN 520 may include RRC idle mode communications module 522 and common small data connection module 524. RRC idle mode communications module 522 may be configured to communicate 517 (e.g., receive small data from and transmit response small data to) with the wireless device 502. In an aspect, RRC idle mode communications module 522 may communicate small data with the wireless device 502 (while the wireless device 502 maintains a RRC idle mode of operations) using various PDU formats (e.g., RLC/MAC PDU, PDCP PDU, etc.). Common small data connection module 524 may be configured to establish, maintain and/or use a common small data connection 521 with SGSN 530. In an aspect, UTRAN 520 and SGSN 530 may establish the common small data connection 521 as an “Iu” connection. In a communication network 500 supported by LTE, the common small data connection 521 may be a “S1” connection. The common small data connection 521 may include a bearer enabled for small data. In an aspect, to assure security, authentication and encryption may be performed between wireless device 502 and SGSN 530. In other words, the common small data connection 521 is a pre-configured common GPRS tunneling protocol (GTP)-U tunnel between SGSN 530 and UTRAN 520 for wireless device(s) 502 served by the UTRAN 520, SGSN 530 pair.

SGSN 530 may include common small data connection module 524 which is configured to enable communication of small data with a wireless device 502. In an aspect SGSN 530 may be in connected 523 to a destination and/or origination network entity for the small data.

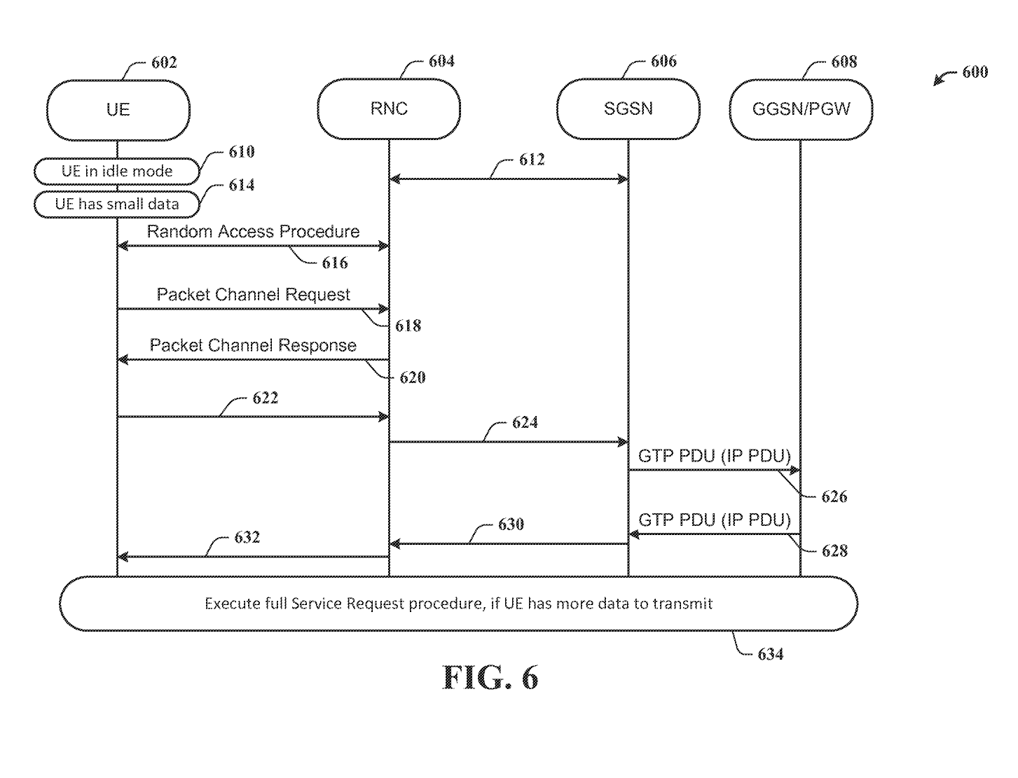

FIGS. 6, 7, 10, and 13 illustrate various methodologies in accordance with various aspects of the presented subject matter. While, for purposes of simplicity of explanation, the methodologies are shown and described as a series of acts or sequence steps, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

FIG. 6 depicts an example communication network 600 in which connectionless data transmission operations may be enabled, according to an aspect. In an aspect, communication network 600 may be a UMTS or LTE based network Communication network 600 may include UE 602, a radio network controller (RNC) 604 (e.g., MME for LTE based networks), a serving general packet radio service (GPRS) Support Node (SGSN) 606, and a gateway GPRS support node (GGSN)/PDN gateway (PGW) 608.

At act 610, the UE 602 is in an RRC idle mode. In an aspect, a UE 602 configured to use the common small data connection, may operate in a special idle state. In such an idle state, the UE 602 has no UE context and does not have a full UE context with the RNC 604. Further, no permanent resource allocation is provided to the UE 602, and there is no RRC connection with the UE. Where a UE 602 is in a RRC connected mode (e.g., when NAS signaling transmissions are used), conventional data communications procedures may be used to communicate any size of data. In an aspect, conventional idle mode mobility procedures may be performed. Handover is not necessary where the UE is configured to use the common small data connection. For example, when UE 602 moves from one cell to another when a common small data connection is active for the UE, the UE 602 may re-initiate the UL small data transmission procedure (acts 618, 620) and may send at least one packet in the new cell if resource allocation (RA) is not changed. In such an aspect, the RNC may run ARQ to repeat packets that may have been lost due to cell change.

At act 612, which occur any time prior to act 624, the RNC 604 and the SGSN 606 may configure a common small data connection (e.g., common Iu/S1). In a communication network 600 supported by Universal Mobile Telecommunications System (UMTS), the RNC 604 to SGSN 606 common small data connection is an “Iu” connection. In a communication network 600 supported by LTE, the common small data connection is a “S1” connection. The common small data connection may include a bearer enabled for small data. In an aspect, to assure security, authentication and encryption may be performed between UE 602 and SGSN 606. In other words, the common small data connection is a pre-configured common GPRS tunneling protocol (GTP)-U tunnel between SGSN 606 and RNC 604 for UEs 602 served by the RNC 604, SGSN 606 pair.

At act 614, the UE 602 may obtain a small amount of data (e.g., small data). In an aspect, a sensor associated with UE 602 may generate a M2M sensor value. In another aspect, UE 602 may generate a “keep alive” message for an application. As used herein, small data may be defined based on a packet size, a number of arrived UL packets, a local UE 602 configuration, an indication from an application to treat the data as small data, etc.

At act 616, UE 602 and RNC 604 may perform a random access procedure. In such an aspect, a random access channel (RACH) may be established.

At act 618, UE 602 may send a packet channel request to RNC 604. In an aspect, the request may include a temporary logical link identifier (TLLI) as a UE identifier. In response to the request, RNC 604 may assign a temporary radio bearer (similar to temporary block flow (TBF) of GPRS) and a Radio Network Temporary identifier (RNTI) for the UE 602. In an aspect, the temporary radio bearer may be valid for a time period, a number of packets, etc. In another aspect, one or more default UE radio capability categories may be defines so as to avoid transmission of a full UE radio capability informational element (IE) in the request.

At act 620, the RNC 604 may send a packet channel response including the RB and the RNTI. In another aspect, the TLLI may be included in the response message for contention resolution.

At act 622, the UE 602 sends the small data (e.g., IP PDU) over the RB. As noted above, in an aspect in which the small data is communicated using a GPRS based protocol stack in a UMTS environment, the PDU may be included in a RLC/MAC PDU. Further in such an aspect, Sub Network Dependent Convergence Protocol (SNDCP), LLC, and service access point identifier (NSAPI) information may be included in the RLC/MAC PDU (e.g., RLC/MAC PDU (TLLI, LLC (SNDCP (NSAPI, IP PDU))). When the GPRS based protocol stack is used in a UMTS environment, header compression may be handled by SNDCP, user plane security may be handled by LLC, and packet data protocol (PDP) context may be identified by NSAPI. Further as noted above, in an aspect in which the small data is communicated using a UMTS based protocol stack, the PDU may be a Packet Data Convergence Protocol (PDCP) PDU.

At act 624, RNC 604 may use the common small data connection, established at act 612, to communicate the small data (e.g., IP PDU) to SGSN. In an aspect in which the small data is communicated using a GPRS based protocol stack in a UMTS environment, the PDU may be included in a GTP PDU. In such an aspect, the GTP PDU may be formatted as GTP PDU (TLLI, LLC (SNDCP (NSAPI, IP PDU))) and communicated over the common connection. In an aspect in which the small data is communicated using a UMTS based protocol stack, the PDU may also be communicated using the GTP PDU. In such an aspect, the GTP PDU may be formatted as GTP PDU (TLLI, NSAPI, IP PDU) and communicated over the common small data connection.

At act 626, SGSN 606 may communicate the small data (e.g., IP PDU) to the PGW 608 using a GTP PDU. In such an aspect, the SGSN 606 may identify the UE context and PDP context per TLLI and NSAPI. In an aspect in which no response is expected and/or generated by a network entity (e.g., PDN), the process may stop here. Where a PDU is expected and/or received, the process may continue to act 628.

At act 628, when downlink user data arrives, GGSN/PGW 608 forwards the user data to SGSN 606.

Similar to acts 622 and 624, but in reverse, at act 630, SGSN 606 may forward the user packet together with the TLLI and NSAPI to RNC 604 over the common small data connection (GTP PDU), when the UE 602 is considered as active by the SGSN 606 (e.g. a timer has not expired), then at act 632, RNC 604 may send the user data and NSAPI to the UE 602 over the temporary radio bearer obtained at act 620.

After the temporary radio bearer is expired, the UE 602 may request temporary radio bearer resource again or execute full service request procedure if it has more data to transmit. If UE has signalling e.g. routing area update to transmit, the UE may setup RRC connection and perform data communication in normal connected mode.

In another operational aspect, the small data may be initiated on the downlink (not shown). In such an aspect, DL data may be received in the SGSN 606 where the UE 602 in idle mode. In such an aspect, the SGSN 606 may initiate network requested service request procedure. When UE 602 receives the paging, the UE 602 can send a dummy packet to the network following the same procedure as UL small data transmission. When SGSN 606 receives the dummy packet, SGSN 606 sends the downlink packet to UE 602 as specified in acts 630 and 632 of UL small data transmission procedure.

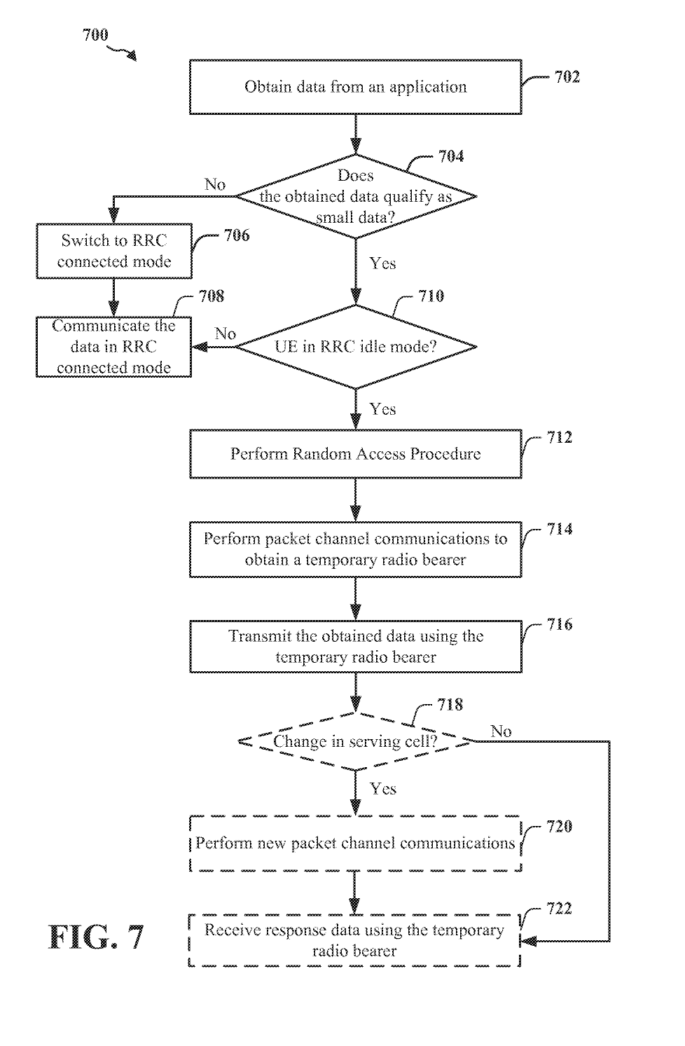

FIG. 7 depicts an example flowchart describing a first process 700 connectionless data transmission operations. In an aspect, the process 700 may be performed by a wireless device.

At block 702, a UE (e.g., wireless device 502) may internally obtain data from an application. In an aspect, the data may be encrypted prior to the transmission. In such an aspect, the encryption may be based on ensuring security between the UE and the SGSN.

At block 704, the UE may determine whether the obtained data qualifies as a small data that may be communicated without changing the UE from a RRC idle mode of operation to a RRC connected module of operation. In an aspect, the data may qualify as small data based on a packet size for the data, a number of uplink (UL) packets for communication by the UE, the UE local configuration, an indication from an application associated with the UE, etc.

If at block 704, the UE determines that the data does not qualify as small data, then at block 706 the UE may switch to a RRC connected mode through performing a service request process, and at block 708, the UE may communicate the data as an IP layer packet data unit (PDU).

By contrast, if at block 704, the UE determines that the data does qualify as small data, then at block 710, the UE determine whether it is currently operating in a RRC idle mode. As used herein, when the UE is in the RRC idle mode it a lacks of a UE context with the UE and the RNC, and lacks a permanent resource allocation. If at block 710, the UE determines that it is operating in a RRC connected mode, then, at block 708, the UE may communicate the data as an IP layer PDU.

By contrast, if the UE is operating in a RRC idle mode, then at block 712, the UE may perform a random access procedure. In such an aspect, a random access channel (RACH) may be established.

At block 714, the UE may perform packet channel communications to obtain a temporary radio bearer. In an aspect, the packet channel communications may include transmission of a packet channel request to the RNC, and reception a packet channel assignment with the temporary radio bearer. In an aspect, the packet channel assignment may be a temporary block flow (TBF) resource allocation. In another aspect, the temporary radio bearer may be valid for a threshold duration, a threshold number of packet transmissions, etc.

At block 716, the UE may transmit the data using the temporary radio bearer over a user plane. In an aspect where the UE is configured to transmit the data using a GPRS based protocol stack in a UMTS or LTE based network, the data may be transmitted using a RLC/MAC PDU. In such an aspect, the RLC/MAC PDU may further include a TLLI identifying the UE, SNDCP information, LLC information, and a NSAPI identifying a PDP context. In an aspect where the UE is configured to transmit the data using a UMTS based protocol stack, the data may be transmitted using a PDCP PDU.

In an optional aspect, at block 718, the UE may detect a change in a serving cell. If at block 718 the UE detects a change in the serving cell, then at optional block 720, the UE may perform packet channel communications again and send at least one packet in the new cell if RA is not changed. Where the new serving cell is supported by the same RNC, the same temporary radio bearer may be used. In such an aspect, the RNC may run ARQ to repeat packets that may have been lost due to cell change.

At optional block 722, the UE may receive data in response to the transmitted small data. In such an aspect, the response data may be received using the temporary radio bearer.

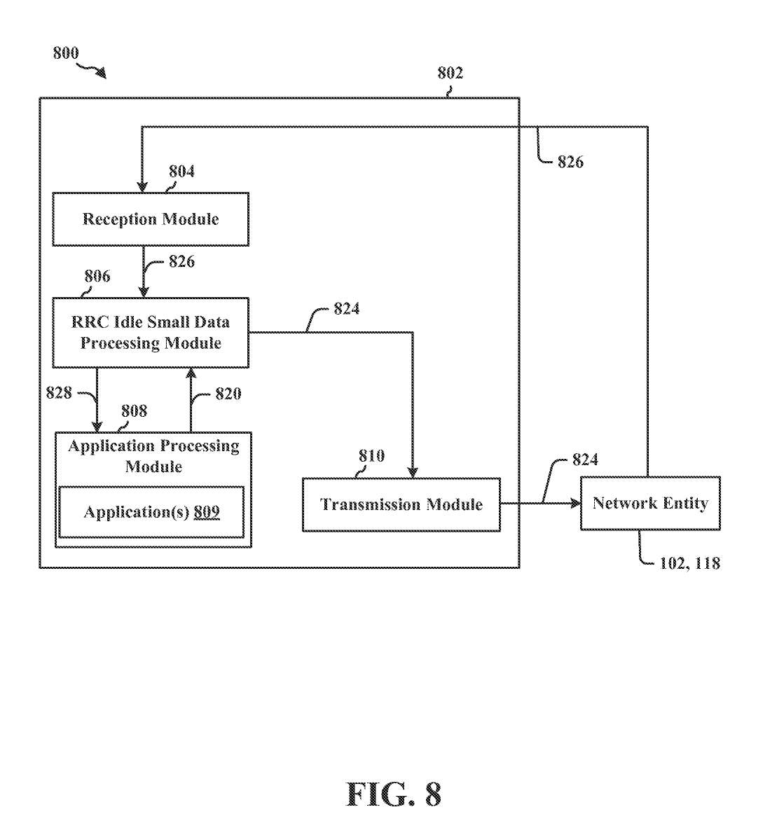

FIG. 8 is a conceptual data flow diagram 800 illustrating the data flow between different modules/means/components in an exemplary apparatus 802. The apparatus may be a wireless device (e.g., M2M end device, M2M gateway, or M2M client device, etc.). The apparatus includes a reception module 804, a RRC idle small data processing module 806, an application processing module 808, and a transmission module 810.

In an operational aspect, application processing module 808 may obtain data 820 from an application 809 for transmission to a network entity (e.g., UTRAN 102, SGSN 118). RRC idle small data processing module 806 may determine that the data 820 qualifies as small data, and may generate a message 824 to communicate the data 820 without switching to a RRC connected mode of operations. In an aspect where the UE is configured to transmit the data 820 using a GPRS based protocol stack in a UMTS or LTE based network, the message 824 may be a RLC/MAC PDU. In such an aspect, the RLC/MAC PDU may further include a TLLI identifying the UE, SNDCP information, LLC information, and a NSAPI identifying a PDP context. In an aspect where the UE is configured to transmit the data 820 using a UMTS based protocol stack, the message 824 may be a PDCP PDU. Thereafter, transmission module 810 may transmit the message 824 to a network entity 102, 118. In an optional aspect, the apparatus 802 may receive, via reception module 804, message 826 with response data 828. In such an optional aspect, RRC idle small data processing module 806 may process the received message 826 to extract the response data 828 and provide the response data 828 to one or more applications 809.

The apparatus may include additional modules that perform each of the steps of the algorithm in the aforementioned call flows and/or flow chart of FIGS. 6 and 7. As such, each step in the aforementioned FIGS. 6 and 7 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

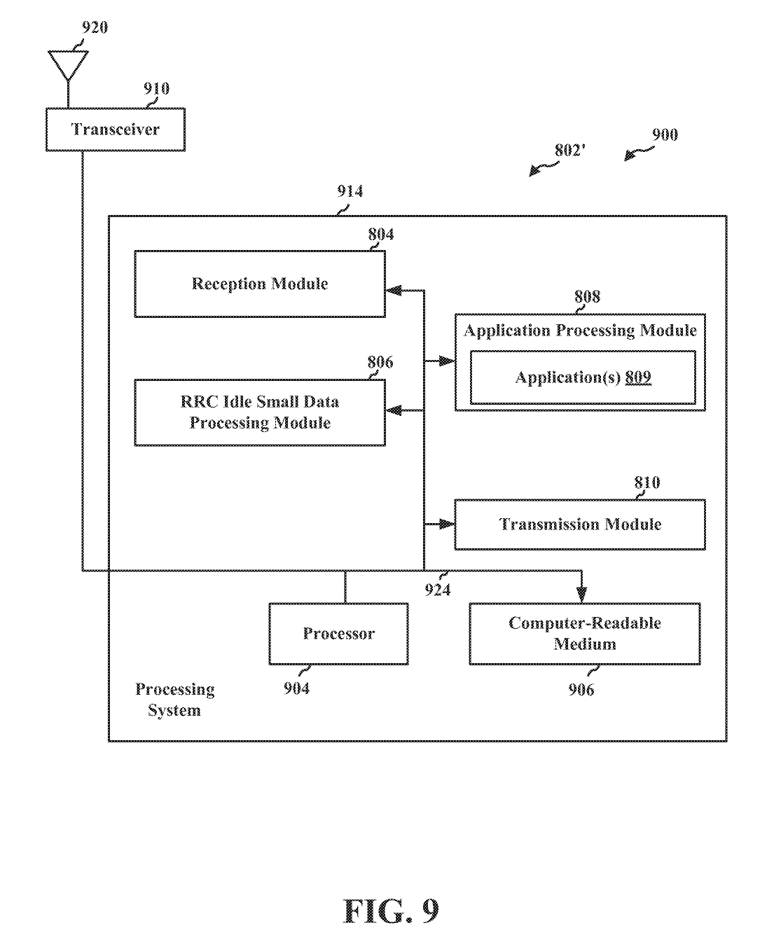

FIG. 9 is a diagram 900 illustrating an example of a hardware implementation for an apparatus 802′ employing a processing system 914. The processing system 914 may be implemented with a bus architecture, represented generally by the bus 924. The bus 924 may include any number of interconnecting buses and bridges depending on the specific application of the processing system 914 and the overall design constraints. The bus 924 links together various circuits including one or more processors and/or hardware modules, represented by the processor 904, the modules 804, 806, 808, 809, 810, and the computer-readable medium 906. The bus 924 may also link various other circuits such as timing sources, peripherals, voltage regulators, and power management circuits, which are well known in the art, and therefore, will not be described any further.

The processing system 914 may be coupled to a transceiver 910. The transceiver 910 is coupled to one or more antennas 920. The transceiver 910 provides a means for communicating with various other apparatus over a transmission medium. The processing system 914 includes a processor 904 coupled to a computer-readable medium 906. The processor 904 is responsible for general processing, including the execution of software stored on the computer-readable medium 906. The software, when executed by the processor 904, causes the processing system 914 to perform the various functions described supra for any particular apparatus. The computer-readable medium 906 may also be used for storing data that is manipulated by the processor 904 when executing software. The processing system further includes at least one of the modules 804, 806, 808, 809, and 810. The modules may be software modules running in the processor 904, resident/stored in the computer-readable medium 906, one or more hardware modules coupled to the processor 904, or some combination thereof. In an aspect, the processing system 914 may be a component of the UE 450 and may include the memory 460 and/or at least one of the TX processor 468, the RX processor 456, and the controller/processor 459.

In one configuration, the apparatus 802/802′ for wireless communication includes means for obtaining a temporary radio bearer for communication of data, that meets one or more criteria for small data transmission, over a user plane in a UMTS or LTE based network, and means for transmitting the data over the user plane using the temporary radio bearer while maintaining the UE in a RRC idle mode. In an aspect, apparatus 802/802′ further include means for receiving response data over the temporary radio bearer, while maintaining the UE in the RRC idle mode, in response to the transmission. In an aspect, apparatus 802/802′ means for obtaining may be further configured to transmit a packet channel request to the RNC, and receive a packet channel assignment with the temporary radio bearer. In an aspect, the apparatus 802/802′ may also include means for detecting a change in a new cell serving the UE after transmission of the data. In such an aspect, the means for transmitting may be configured to transmit a new packet channel request to the RNC, and the means for receiving may be further configured to receive a new packet channel assignment with the temporary radio bearer based on a determination that the RNC supports the new cell.

As described supra, the processing system 914 may include the TX Processor 468, the RX Processor 456, and the controller/processor 459. As such, in one configuration, the aforementioned means may be the TX Processor 468, the RX Processor 456, and the controller/processor 459 configured to perform the functions recited by the aforementioned means.

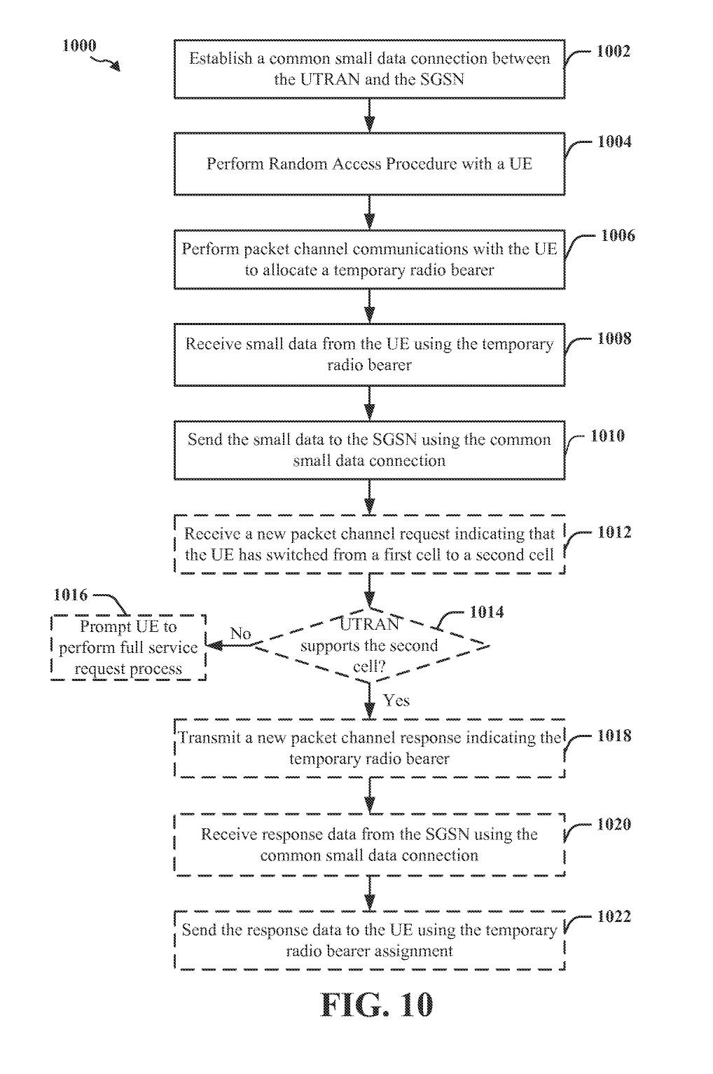

FIG. 10 is a flow chart of a second process 1000 of wireless communication. The method may be performed by a UTRAN (e.g., a nodeB, an eNodeB, a RNC).

At block 1002, the UTRAN may establish a common small data connection with a SGSN. In an aspect, the common small data connection may be a common Iu connection. In another aspect, the common small data connection may be a common S1 connection. In such an aspect, the UTRAN is enabled in a LTE or UMTS supported network with an EPC network.

At block 1004, the UTRAN may perform a random access procedure with a UE. In such an aspect, the random access procedure may establish a RACH.

At block 1006, the UTRAN may perform packet channel communications with the UE to allocate a temporary radio bearer. In an aspect, the packet channel communications may include reception of a packet channel request from the UE, and transmission of a packet channel assignment with the temporary radio bearer. In an aspect, the packet channel assignment may be a temporary block flow (TBF) resource allocation. In another aspect, the temporary radio bearer may be valid for a threshold duration, a threshold number of packet transmissions, etc.

At block 1008, the UTRAN may receive (e.g., via an eNB) small data over a user plane from the UE using the temporary radio bearer. In an aspect, the data may qualify as small data based on a packet size for the data, a number of uplink (UL) packets for communication by the UE, the UE local configuration, an indication from an application associated with the UE, etc.

At block 1010, the UTRAN may send the small data to a SGSN using the common small data connection. In an aspect in which the UTRAN is configured to send the data using a GPRS based protocol stack in a UMTS or LTE based network, the small data may be sent using a GTP PDU. In such an aspect, the GTP PDU may further include a TLLI identifying the UE, SNDCP information, LLC information, and a NSAPI identifying PDP context. In an aspect in which the UTRAN is configured to send the data using a UMTS based protocol stack, the small data may also be sent using a GTP PDU. In such an aspect, GTP PDU may further include a TLLI identifying the UE and a NSAPI identifying PDP context.

In an optional aspect, at block 1012, the UTRAN may receive a new packet channel request from the UE in the idle mode. In such an aspect, the new packet channel request indicates that the UE is served by a new cell.

Further in the optional aspect, at block 1014 the UTRAN may determine whether the new cell is supported by the same RNC. If at block 1014, the UTRAN determines that the new cell is not supported by the current RNC, then at block 1016, the UTRAN may prompt the UE to perform a full service request procedure with the new RNC. By contrast, if at block 104, the UTRAN determines that the UE is still served by the same RNC, then at block 1018, the UTRAN may transmit a new packet channel response with the existing temporary radio bearer.

In another optional aspect, at block 1020, the UTRAN may receive response data from the SGSN using the common small data connection. In such an optional aspect, at block 1022, the UTRAN may relay the response data to the UE using the temporary radio bearer.

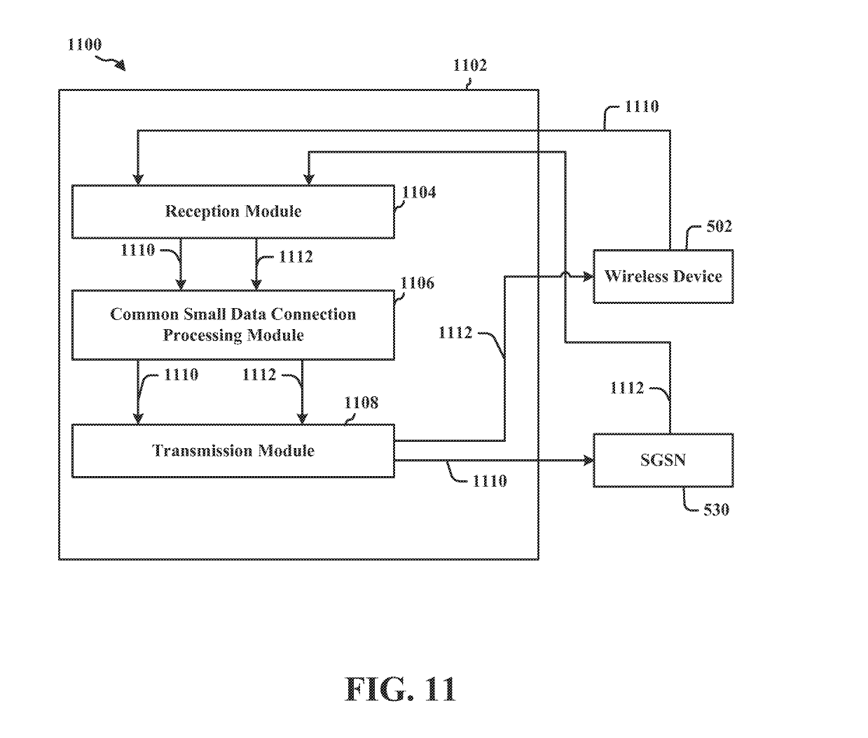

FIG. 11 is a conceptual data flow diagram 1100 illustrating the data flow between different modules/means/components in an exemplary apparatus 1102. The apparatus may be a UTRAN (e.g., RNC). The apparatus 1102 includes a reception module 1104, a common small data connection processing module 1106, and a transmission module 908.

In an operational aspect, apparatus 1102 (e.g., UTRAN 520) may receive data 1110 from wireless device 502 over a user plane at reception module 1104. In an aspect, the data 1110 is received over a temporary radio bearer while the wireless device 502 is in a RRC idle mode. Common small data connection processing module 1106 may process the received data 1110. In an aspect, common small data connection processing module 1106 may process the received data 1110 and package the data in a format that may be communicated over a common small data connection. Thereafter, the common small data connection processing module 1106 transmit the data 1110 to SGSN 530 via the common small data connection and using transmission module 1108. In an optional aspect, reception module 1104 may receive response data 1112 from the SGSN 530 via the common small data connection. In such an optional aspect, common small data connection processing module 1106 may process the received response data 1112 and package the data in a format that may be communicated to the UE using the temporary radio bearer. Thereafter, the response data 1112 may be transmitted to the wireless device 502 via transmission module 1108.

The apparatus may include additional modules that perform each of the steps of the algorithm in the aforementioned call flow and/or flow charts of FIGS. 6 and 10. As such, each block in the aforementioned FIGS. 6 and 10 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

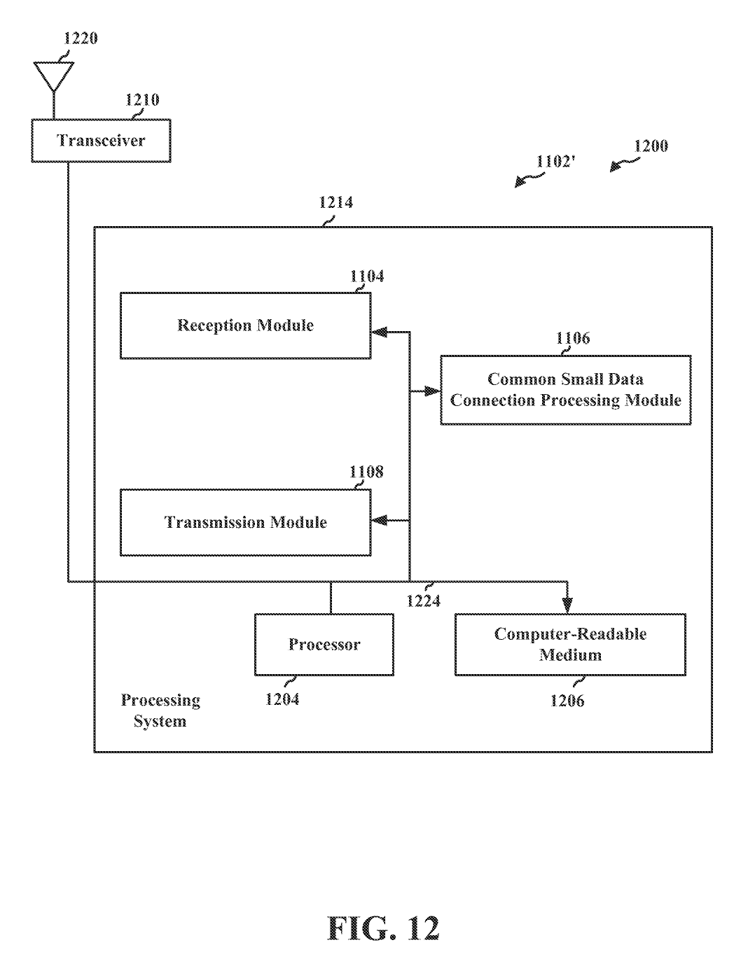

FIG. 12 is a diagram 1200 illustrating an example of a hardware implementation for an apparatus 1102′ employing a processing system 1214. The processing system 1214 may be implemented with a bus architecture, represented generally by the bus 1224. The bus 1224 may include any number of interconnecting buses and bridges depending on the specific application of the processing system 1214 and the overall design constraints. The bus 1224 links together various circuits including one or more processors and/or hardware modules, represented by the processor 1204, the modules 1104, 1106, 1108, and the computer-readable medium 1206. The bus 1224 may also link various other circuits such as timing sources, peripherals, voltage regulators, and power management circuits, which are well known in the art, and therefore, will not be described any further.

The processing system 1214 may be coupled to a transceiver 1210. The transceiver 1210 is coupled to one or more antennas 1220. The transceiver 1210 provides a means for communicating with various other apparatus over a transmission medium. The processing system 1214 includes a processor 1204 coupled to a computer-readable medium 1206. The processor 1204 is responsible for general processing, including the execution of software stored on the computer-readable medium 1206. The software, when executed by the processor 1204, causes the processing system 1214 to perform the various functions described supra for any particular apparatus. The computer-readable medium 1206 may also be used for storing data that is manipulated by the processor 1204 when executing software. The processing system further includes at least one of the modules 1104, 1106, and 1108. The modules may be software modules running in the processor 1204, resident/stored in the computer-readable medium 1206, one or more hardware modules coupled to the processor 1204, or some combination thereof. The processing system 1214 may be a component of the network entity 410 and may include the memory 476 and/or at least one of the TX processor 416, the RX processor 470, and the controller/processor 475.

In one configuration, the apparatus 1102/1102′ for wireless communication includes means for receiving, over a temporary radio bearer assignment, data that meets one or more criteria for small data transmission over a user plane from a UE in an idle mode, and means for sending the data to a SGSN using a common small data connection. In an aspect, apparatus 1102/1102′ means for receiving and transmitting may be further configured to receive response data from the SGSN, and send the response data to the UE using the temporary radio bearer assignment. In an aspect, apparatus 1102/1102′ means for receiving and transmitting may be further configured to receive a packet channel request from the UE in the idle mode, and transmit the temporary radio bearer assignment to the UE. In an aspect, apparatus 1102/1102′ may further include means for establishing the common small data connection between the UTRAN and the SGSN. In an aspect, apparatus 1102/1102′ means for receiving may be further configured to receive a new packet channel request from the UE in the idle mode. In an aspect, the new packet channel request indicates that the UE is served by a second cell. In such an aspect, the apparatus 1102/1102′ may further include means for determining that the UTRAN supports serving with the second cell, and the means for transmitting may be further configured to transmit the temporary radio bearer assignment to the UE. The aforementioned means may be one or more of the aforementioned modules of the apparatus 1102 and/or the processing system 1214 of the apparatus 1102′ configured to perform the functions recited by the aforementioned means. As described supra, the processing system 1214 may include the TX Processor 416, the RX Processor 470, and the controller/processor 435. As such, in one configuration, the aforementioned means may be the TX Processor 416, the RX Processor 470, and the controller/processor 475 configured to perform the functions recited by the aforementioned means.

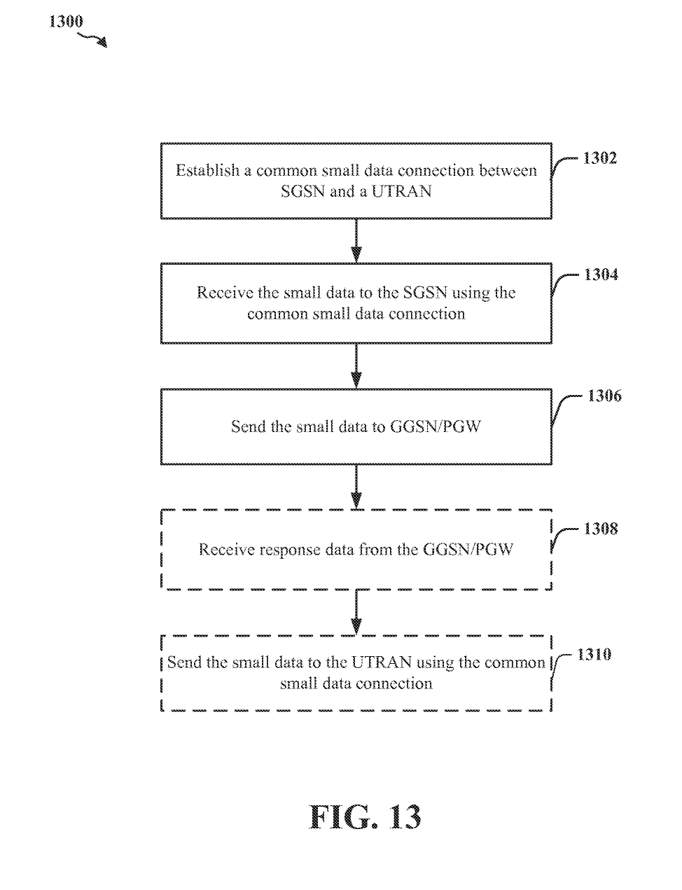

FIG. 13 is a flow chart of a third process 1300 of wireless communication. The method may be performed by a SGSN.

At block 1302, the SGSN may establish a common small data connection with a UTRAN. In an aspect, the common small data connection may be a common Iu connection. In another aspect, the common small data connection may be a common S1 connection. In such an aspect, the UTRAN and the SGSN are enabled in a LTE or UMTS supported network with an EPC network.

At block 1304, the SGSN may receive the data to using the common small data connection. In an aspect in which the SGSN is configured to receive the data using a GPRS based protocol stack in a UMTS or LTE based network, the small data may be received using a GTP PDU. In such an aspect, the GTP PDU may further include a TLLI identifying the UE, SNDCP information, LLC information, and a NSAPI identifying PDP context. In an aspect in which the SGSN is configured to receive the data using a UMTS based protocol stack, the small data may also be received using a GTP PDU. In such an aspect, GTP PDU may further include a TLLI identifying the UE and a NSAPI identifying PDP context. In an aspect, the data may qualify as small data based on a packet size for the data, a number of uplink (UL) packets for communication by the UE, the UE local configuration, an indication from an application associated with the UE, etc.

At block 1306, the SGSN may send the data to a destination network entity (e.g., via GGSN/PGW).

In an optional aspect, at block 1308, the SGSN may receive response data from the network entity (e.g., via GGSN/PGW). In such an optional aspect, the SGSN may send the response data to the UTRAN using the common small data connection.

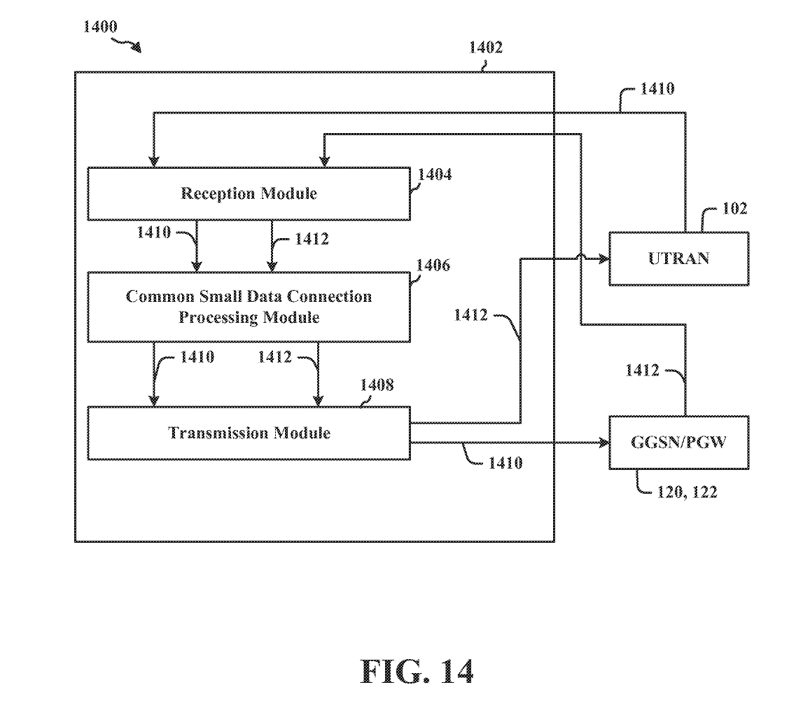

FIG. 14 is a conceptual data flow diagram 1400 illustrating the data flow between different modules/means/components in an exemplary apparatus 1402. The apparatus may be a SGSN. The apparatus 1402 includes a reception module 1404, a common small data connection processing module 1406, and a transmission module 908.

In an operational aspect, apparatus 1402 (e.g., SGSN 530) may receive data 1410 from UTRAN 102 at reception module 1404. In an aspect, the data 1410 is received over a common small data connection with the UTRAN. Common small data connection processing module 1406 may process the received data 1410. In an aspect, common small data connection processing module 1406 may process the received data 1410 and package the data in a format that may be communicated over an IP layer communicate with a destination entity (e.g., via GGSN/PGW 120, 122). Thereafter, the common small data connection processing module 1406 transmit the data 1410 to destination entity using transmission module 1408. In an optional aspect, reception module 1404 may receive response data 1412 from the destination entity (e.g., via GGSN/PGW 120, 122). In such an optional aspect, common small data connection processing module 1406 may process the received response data 1412 and package the data in a format that may be communicated to the UTRAN using the common small data connection. Thereafter, the response data 1412 may be transmitted to the UTRAN 520 via transmission module 1408.

The apparatus may include additional modules that perform each of the steps of the algorithm in the aforementioned call flow and/or flow charts of FIGS. 6 and 13. As such, each block in the aforementioned FIGS. 6 and 13 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

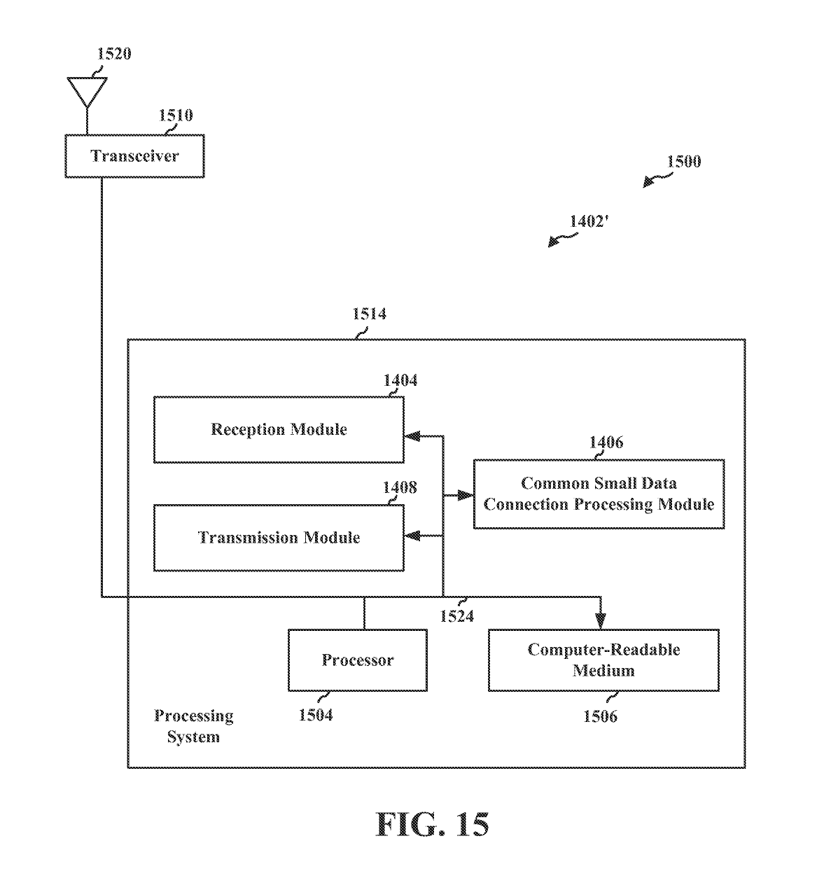

FIG. 15 is a diagram 1500 illustrating an example of a hardware implementation for an apparatus 1402′ employing a processing system 1514. The processing system 1514 may be implemented with a bus architecture, represented generally by the bus 1524. The bus 1524 may include any number of interconnecting buses and bridges depending on the specific application of the processing system 1514 and the overall design constraints. The bus 1524 links together various circuits including one or more processors and/or hardware modules, represented by the processor 1504, the modules 1404, 1406, 1408, and the computer-readable medium 1506. The bus 1524 may also link various other circuits such as timing sources, peripherals, voltage regulators, and power management circuits, which are well known in the art, and therefore, will not be described any further.

The processing system 1514 may be coupled to a transceiver 1510. The transceiver 1510 is coupled to one or more antennas 1520. The transceiver 1510 provides a means for communicating with various other apparatus over a transmission medium. The processing system 1514 includes a processor 1504 coupled to a computer-readable medium 1506. The processor 1504 is responsible for general processing, including the execution of software stored on the computer-readable medium 1506. The software, when executed by the processor 1504, causes the processing system 1514 to perform the various functions described supra for any particular apparatus. The computer-readable medium 1506 may also be used for storing data that is manipulated by the processor 1504 when executing software. The processing system further includes at least one of the modules 1404, 1406, and 1408. The modules may be software modules running in the processor 1504, resident/stored in the computer-readable medium 1506, one or more hardware modules coupled to the processor 1504, or some combination thereof. The processing system 1514 may be a component of the network entity 410 and may include the memory 476 and/or at least one of the TX processor 416, the RX processor 470, and the controller/processor 475.

In one configuration, the apparatus 1402/1402′ for wireless communication includes means for receiving data over a common small data connection from a Universal Mobile Telecommunications System (UMTS) terrestrial radio access network (UTRAN), and means for sending the data to a GGSN/PGW. In an aspect, the data may meet one or more criteria for small data transmission using a user plane from a UE in an idle mode. In an aspect, apparatus 1402/1402′ means for receiving and transmitting may be further configured to receive response data from the GGSN/PGW, and send the response data to the SGSN to be communicated to the UE. In an aspect, apparatus 1402/1402′ may further include means for establishing the common small data connection between the UTRAN and the SGSN. The aforementioned means may be one or more of the aforementioned modules of the apparatus 1402 and/or the processing system 1514 of the apparatus 1402′ configured to perform the functions recited by the aforementioned means. As described supra, the processing system 1514 may include the TX Processor 416, the RX Processor 470, and the controller/processor 435. As such, in one configuration, the aforementioned means may be the TX Processor 416, the RX Processor 470, and the controller/processor 475 configured to perform the functions recited by the aforementioned means.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

1. A method of communications for a user equipment (UE), comprising:
obtaining a temporary radio bearer for communication of data, that meets one or more criteria for small data transmission, over a user plane in a Universal Mobile Telecommunications System (UMTS) or long term evolution (LTE) based network; and
transmitting the data, over the user plane, using the temporary radio bearer while maintaining the UE in a radio resource control (RRC) idle mode.

2. The method of claim 1, further comprising:
receiving response data over the temporary radio bearer, while maintaining the UE in the RRC idle mode, in response to the transmission.

3. The method of claim 1, wherein the data is encrypted prior to the transmission, and wherein the encryption is based on security between the UE and a serving general packet radio service (GPRS) Support Node (SGSN).

4. The method of claim 1, wherein the one or more criteria comprise at least one of:
a packet size for the data, a number of uplink (UL) packets for communication by the UE, the UE local configuration, or an indication from an application associated with the UE.

5. The method of claim 1, wherein the obtaining the temporary radio bearer further comprises:
transmitting a packet channel request to the RNC; and
receiving a packet channel assignment with the temporary radio bearer.

6. The method of claim 1, further comprising:
detecting a change in a new cell serving the UE after transmission of the data;
transmitting a new packet channel request to the RNC; and
receiving a new packet channel assignment with the temporary radio bearer based on a determination that the RNC supports the new cell.

7. A method of communications for a Universal Mobile Telecommunications System (UMTS) terrestrial radio access network (UTRAN), comprising:
receiving, over a temporary radio bearer assignment, data that meets one or more criteria for small data transmission over a user plane from a user equipment (UE) in a radio resource control (RRC) idle mode; and
sending the data to a serving general packet radio service (GPRS) Support Node (SGSN) using a common small data connection.

8. The method of claim 7, further comprising:
receiving a packet channel request from the UE in the idle mode; and
transmitting the temporary radio bearer assignment to the UE.

9. The method of claim 7, further comprising:
establishing the common small data connection between the UTRAN and the SGSN.

10. The method of claim 8, wherein the packet channel request indicates that the UE is served by a first cell, and further comprising:
receiving a new packet channel request from the UE in the idle mode, wherein the new packet channel request indicates that the UE is served by a second cell;
determining that the UTRAN supports serving with the second cell; and
transmitting the temporary radio bearer assignment to the UE.

11. A method of communications for a service (GPRS) Support Node (SGSN), comprising:
receiving data over a common small data connection from a Universal Mobile Telecommunications System (UMTS) terrestrial radio access network (UTRAN), wherein the data meets one or more criteria for small data transmission over a user plane from a user equipment (UE) in a radio resource control (RRC) idle mode; and
sending the data to a gateway GPRS support node (GGSN)/PDN gateway (PGW).

12. The method of claim 11, further comprising:
establishing the common small data connection between the UTRAN and the SGSN.

13. An apparatus for communications for a user equipment (UE), comprising:
means for obtaining a temporary radio bearer for communication of data, that meets one or more criteria for small data transmission, over a user plane in a Universal Mobile Telecommunications System (UMTS) or long term evolution (LTE) based network; and
means for transmitting the data over the user plane using the temporary radio bearer while maintaining the UE in a radio resource control (RRC) idle mode.

14. An apparatus for communications for a Universal Mobile Telecommunications System (UMTS) terrestrial radio access network (UTRAN), comprising:
means for receiving, over a temporary radio bearer assignment, data that meets one or more criteria for small data transmission over a user plane from a user equipment (UE) in a radio resource control (RRC) idle mode; and
means for sending the data to a serving general packet radio service (GPRS) Support Node (SGSN) using a common small data connection.

15. An apparatus for communications for a service (GPRS) Support Node (SGSN), comprising:
means for receiving data over a common small data connection from a Universal Mobile Telecommunications System (UMTS) terrestrial radio access network (UTRAN), wherein the data meets one or more criteria for small data transmission over a user plane from a user equipment (UE) in a radio resource control (RRC) idle mode; and
means for sending the data to a gateway GPRS support node (GGSN)/PDN gateway (PGW).
